(19) United States
(12) Patent Application Publication
(10) Pub. No.: US 2003/0187987 A1
(43) Pub. Date: Oct. 2, 2003

(54) Storage area network with multiple pathways for command paths

(76) Inventors: Randall E. Messick, Boise, ID (US); E. Jeffrey Peone, Boise, ID (US); Todd Hayden, Boise, ID (US)

Correspondence Address: HEWLETT-PACKARD COMPANY, Intellectual Property Administration, P.O.Box 272400, Fort Collins, CO, 80527-2400, US

(21) Appl. No.: 10/112,284

(22) Filed: Mar. 29, 2002

(51) Int. Cl. G06F 15/16

(52) U.S. Cl. 709/226

(57) ABSTRACT

A storage area network preferably includes a client device, a data storage device, and at least two data pathways between the client device and the data storage device in which the client device can establish a command path for controlling the data storage device. The client device is configured to establish a new command path in a different pathway upon failure of an existing command path.

### FIELD OF THE INVENTION

The present invention relates to the field of data storage. In particular, the present invention relates to a storage area network that includes at least two data pathways between a client device and a data storage device in which the client device can establish a command path for controlling the data storage device.

### BACKGROUND OF THE INVENTION

The use of computers and computer networks pervades virtually every business and other enterprise in the modern world. With computers, users generate vast quantities of data that can be stored for a variety of purposes. This storehouse of data can grow at a phenomenal pace and become critically valuable to those who have generated it. Consequently, there is an ever-present need for data storage systems that improve on capacity, speed, reliability, etc.

In a single computer, the primary data storage device is usually a hard drive with a storage capacity measured in gigabytes. Additionally, computers may store data using such devices as CD-ROM drives, floppy disk drives, tape drives, etc. Within a computer network, the computers of the network may also store data on network servers or other data storage devices, such as those mentioned above, that are accessible through the network. For larger systems with even greater data storage needs, arrays of data storage disks may be added to the network.

Storage Area Networks (SANs) are an emerging technology being implemented to accommodate high-capacity data storage devices, particularly disk arrays, within a network. A SAN is essentially a high-speed network between client devices, such as servers, and data storage devices, particularly disk arrays. A SAN overcomes the limitations and inflexibility of traditional attached data storage.

### SUMMARY OF THE INVENTION

An embodiment according to the present invention provides, among other things, a storage area network that includes a client device, a data storage device, and at least two data pathways between the client device and the data storage device in which the client device can establish a command path for controlling the data storage device. The client device is configured to establish a new command path in a different pathway upon failure of an existing command path.

Another embodiment according to the present invention also provides a management station for a storage area network that includes a client device, a data storage device, and at least two data pathways between the client device and the data storage device in which the client device can establish a command path for controlling the data storage device. The management station is configured to establish a new command path in a different pathway upon failure of an existing command path.

Another embodiment according to the present invention also provides a method of operating a storage area network that includes a client device, a data storage device, and at least two data pathways between the client device and the data storage device in which the client device can establish a command path for controlling the data storage device. This method is conducted, upon failure of an existing command path between the client device and the data storage device, by establishing a second command path between the client device and the data storage device in one of the pathways.

Another embodiment according to the present invention also provides a method of assembling a storage area network by providing at least two data pathways between a client device and a data storage device in which the client device can establish a command path for controlling the data storage device and configuring the client device to establish a new command path in a different pathway upon failure of an existing command path.

### BRIEF DESCRIPTION OF THE DRAWINGS

The accompanying drawings illustrate embodiments of the present invention and are a part of the specification. Together with the following description, the drawings demonstrate and explain the principles of the present invention. The illustrated embodiments are examples of the present invention and do not limit the scope of the invention.

FIG. 1 is a block diagram illustrating a first embodiment of a Storage Area Network according to principles of the present invention with redundant command pathways between a management station and storage disk array.

FIG. 2 is a block diagram illustrating another embodiment of a Storage Area Network according to principles of the present invention with two redundant command pathways between a management station and storage disk array.

FIG. 3 is a block diagram illustrating another embodiment of a Storage Area Network according to principles of the present invention with two redundant command pathways between a management station and storage disk array.

FIG. 4 is a flow chart illustrating the operation of a Storage Area Network with redundant command pathways according to principles of the present invention.

Throughout the drawings, identical reference numbers designate similar, but not necessarily identical, elements.

### DETAILED DESCRIPTION OF THE PREFERRED EMBODIMENTS

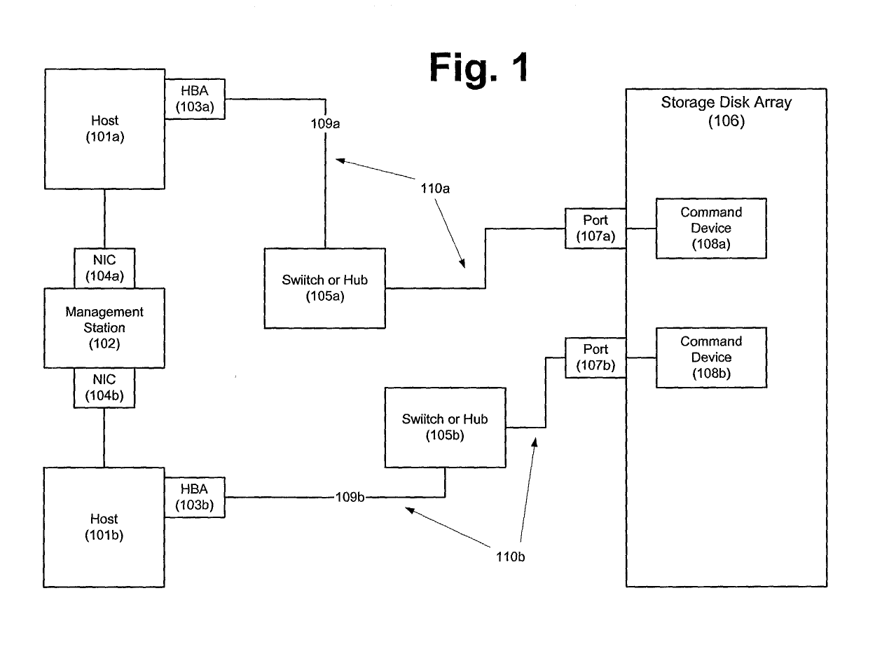

FIG. 1 is a block diagram illustrating a first embodiment of a Storage Area Network (SAN) according to principles of the present invention. The SAN illustrated in FIG. 1 features redundant command paths between a management station and data storage device, for example, a storage disk array.

A SAN may be described as having a client side and a data storage side. The data storage side is comprised of data storage devices, especially high-capacity data storage devices such as disk arrays. The client side comprises the servers, computers and other devices that generate or use the data stored on the data storage side of the SAN.

Consequently, two distinct types of information must flow between the client side and the data storage side of a SAN. These are (1) the data being stored or retrieved and (2) the commands that operate the data storage devices of the SAN to cause data storage, retrieval, etc. Thus, the commands to the data storage side of the SAN cause the storage devices to, for example, create blocks of storage (volumes or logical units), delete such blocks of storage, mirror blocks of storage, restrict the bandwidth of a block of storage or gather performance data for a block of storage. The commands may cause the storage devices to store, retrieve, copy, delete or otherwise manipulate the system's data. These commands are distinct from the data that is being stored, retrieved, etc., by the network in response to the commands.

Typically, the commands in a SAN are in-band, SCSI-compliant commands. SCSI stands for Small Computer Systems Interface (SCSI) which is a high-speed interface, including a communication protocol, that can connect a processor or computer to devices such as hard drives, CD-ROM drives, floppy drives, tape drives, scanners, and printers. A single SCSI can connect up to seven devices. While a SAN may use SCSI-compliant commands, the SAN also seeks to increase the speed and capacity of the interaction between the clients and data storage devices beyond what has traditionally been possible with an SCSI.

Consequently, a typical data link in a SAN preferably includes a host bus adapter (HBA) (e.g., 103a) that links a client device, e.g., a host computer or server, to a communications link or data pathway, such as a fiber optic cable that carries, for example, a Fibre Channel. The Fibre Channel is a communication link governed by a standard protocol that operates over a fiber optic or copper cable. The Fibre Channel can wrap SCSI-compliant commands and deliver them to the data storage devices of the SAN. As used herein, the term “fibre channel” will, refer generally to both the fiber optic or other type of cable and the data link carried by that cable according to the fibre channel standard. The fiber optical channel links the client side of the SAN to the data storage side of the SAN, e.g., data storage devices such as a storage disk array (106). The fibre channel HBA also enables organizations to connect to SANs that may be hosted by other parties and that are experiencing tremendous growth in enterprise storage networking environments.

The HBA preferably provides, for example, a link between a fiber optic cable and a PCI bus of the client device. A Peripheral Component Interconnect (PCD bus is a 64-bit personal computer local bus that runs at 33 or 66 MHz. At 32 bits and 33 MHz, it yields a throughput rate of 133 MBps. Thus, a PCI bus provides a high-speed connection with peripherals. The PCI bus is processor independent and typically plugs into a PCI slot on the motherboard of the client device. Thus, a PCI-to-fibre channel host bus adapter (HBA) enables high-speed data transfers between PCI-based servers and a fiber channel.

As shown in FIG. 1, a management station (102) controls the client side of the SAN. The management station (102) will be networked to one or more host devices (101), e.g., servers, computers, etc. In the embodiment of FIG. 1, the management station (102) is networked to two host devices (101a, 101b). Preferably, the management station (102) is connected to each of the two hosts (101a, 101b) through a network interface card (NIC) (104a, 104b).

As shown in FIG. 1, each of the hosts (101a, 101b) preferably has a host bus adapter (HBA) (103a, 103b) to create a connection to the data storage side of the SAN, e.g., the storage disk array (106). The first host (101a) has an HBA (103a) that connects the host (101a) with a fibre channel (109a). This channel (109a) may be routed through a switch or hub (105a), or other network connections, but eventually connects to a port (107a) of the storage disk array (106).

This pathway (110a) between the host (101a) and the disk array (106) may contain both a data path and a command path. In other words, the pathway (110a) may carry data being sent to or from the disk array (106) as well as commands from the client side for controlling the disk array (106). Commands are taken from the data stream and implemented by a command device (108a) in the storage disk array (106). Any data pathway that connects to a command device (108a) can be made to include a command path.

Similarly, the second host (110b) has an HBA (103b) that connects the host (101b) with a fibre channel (109b). Again, this channel (109b) may be routed through a switch or hub (105b), or other network connections, but eventually connects to a port (107b) of the storage disk array (106).

As before, this pathway (110b) between the second host (101b) and the disk array (106) may contain both a data path and a command path. In other words, the pathway (110b) may carry data being sent to or from the disk array (106) as well as commands from the client side for controlling the disk array (106). Commands are taken from the data stream and implemented by a command device (108b) in the storage disk array (106).

Generally, it is only necessary to have one command path between the client side of the SAN and the data storage side. With that one command path, the client side, e.g., the management station (102), can send commands to the data storage side, e.g., the disk array (106), and thereby appropriately control the data storage.

However, if there is any malfunction in that command path, or that command path is interrupted for any reason, the client side of the SAN will have no way to control the data storage devices of the network on the data storage side of the SAN. Consequently, any application or applications being supported on the client side of the SAN may have to be discontinued. Additionally, without a command path, the application controlling the SAN will be unable to make scheduled bandwidth priority changes until the command path is restored.

As the demand for data storage grows, so also does the demand that access to, and control of, that storage be reliable and always, or nearly always, available. Downtime for the SAN due to the interruption or malfunction of the command path is to be strictly avoided.

It is for this reason that a SAN according to principles of the present invention preferably incorporates at least two pathways (110a, 110b) between the client side and the data storage side of the SAN. As shown in FIG. 1, each of the two pathways (110a, 110b) includes a command device (108a, 108b). Because each of the two pathways (110a, 110b) includes a command device (108a, 108b) in the disk array (106), either pathway (110a, 110b) can carry a command path between the management station (102) and the storage disk array (106).

One of the pathways (110a, 110b) can be designated as the primary or default pathway with a command path being established through that pathway. In the event that pathway (e.g., 110a) is later interrupted for any reason, the management station (102) can “fail over” to the other pathway (e.g., 110b) and establish a command path through that alternate pathway.

A pathway (110a, 110b) may fail due to the failure of any component of which that pathway consists. For example, a pathway (110) can fail due to the failure or malfunction of the host (101), the HBA (103), the switches or hubs (105), the port (107) or the command device (108) that compose that pathway (110). Damage to any of these components or to the fibre channel and other wiring that connect them may cause an interruption of the pathway (110).

However, with at least two pathways between the client side and data storage side of the SAN, there are two possible pathways in which a command path can be established. Consequently, whenever a command path is lost or interrupted, the system can resort to the other pathway and establish a new command path therein.

In this way, the SAN become more robust and reliable. The data storage side will be more consistently available to the client system because loss of a command path will not necessarily mean the end of controlled access to the system's data cache. Both pathways (110a, 110b) can be used for carrying data to the storage device (e.g., 106) for storage or data that is being retrieved from the storage device (e.g., 106) to the client side of the SAN.

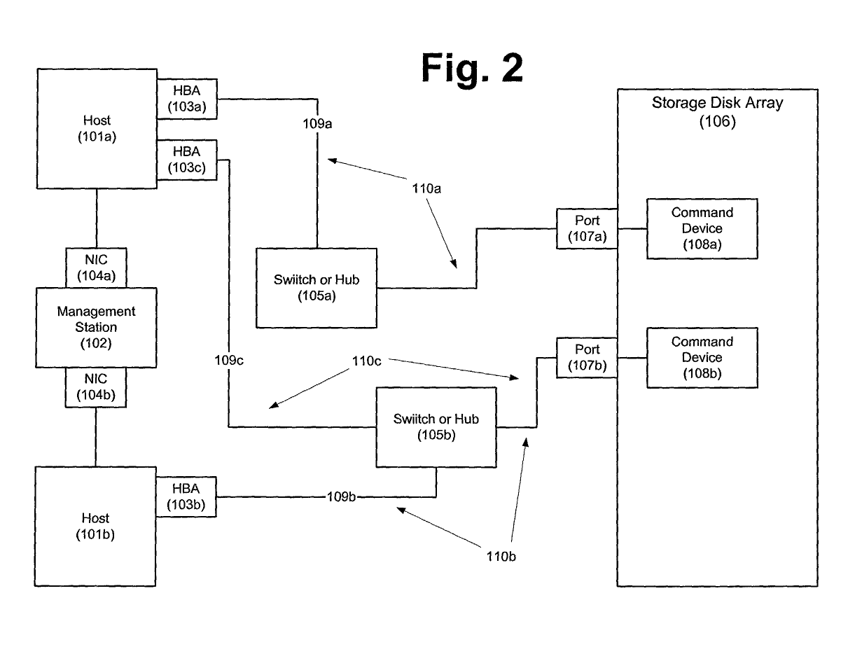

FIG. 2 is a block diagram illustrating another embodiment of a Storage Area Network (SAN) according to principles of the present invention with two redundant command pathways between a management station and storage disk array. The embodiment illustrated in FIG. 2 demonstrates that a SAN can include more than two pathways through which a backup command path can be established.

The embodiment illustrated in FIG. 2 is similar to that of FIG. 1 in many respects. Consequently, a redundant explanation of components already discussed will be omitted.

In the SAN of FIG. 2, a third pathway (e.g., 110c) is formed between the client side of the SAN and the data storage side. This pathway can be configured in a variety of ways, all of which are within the scope of the present invention. Alternative means of forming the third pathway will be discussed in connection with the specific example illustrated in FIG. 2.

As shown in FIG. 2, one of the host devices (101a) is provided with a second HBA (103c). This second HBA (103c) connects the host (101a) to a fibre channel (109c). The fibre channel (109c) is routed to the disk array (106).

In FIG. 2, the fibre channel (109c) is routed through switch or hub (105b) and then through port (107b) to command device (108b). However, the fibre channel (109c) could be routed through any other alternate path to a command device (108). For example, the fibre channel (109c) could be routed through switch or hub (105a) to command device (108a). The fibre channel (109c) could also be routed through a separate switch or hub and port to a command device other than those used by the other two fibre channels (110a, 110b).

With three pathways ( 110a, 110b, 110c), the SAN becomes extremely robust and reliable. If a command path is interrupted on any of the three pathways, there are at least two other pathways through which a command path can be established. Thus, when any command path fails, the system will simply fail over to one of the other pathways and establish a command path there. Consequently, all three pathways would have to fail before the SAN is left without a command path between the client and data storage sides.

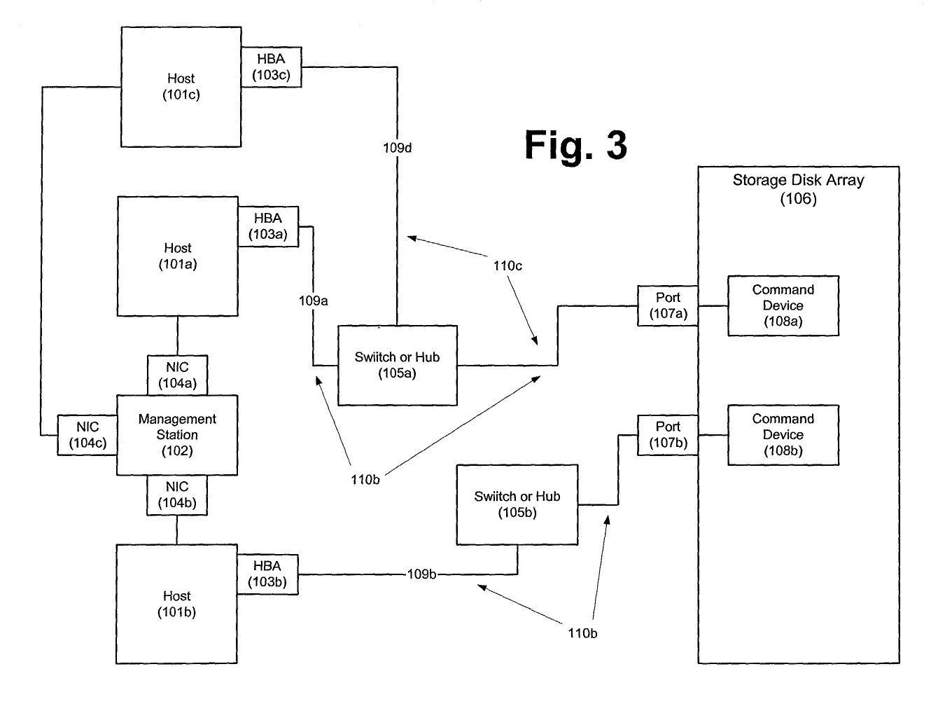

As an alternative to the embodiment in FIG. 2, it should also be noted that the third pathway (110c) can be created by adding a third host (101c) to the client system. This embodiment is illustrated in FIG. 3. As shown in FIG. 3, the third host (101c) is preferably networked to the management station (102) through a network interface card (104c).

The third host (101c) has a third HBA (103c). This adapter (103c) connects the host (101c) to a fibre channel (109d). The fibre channel (109d) can be routed through either switch or hub (105) to a command device (108) in the disk storage array (106). Alternatively, the fibre channel (109d) could be routed through separate switches and hubs that are not shown to an illustrated port of the array (106) or to a third port (not shown) of the array.

In the embodiment illustrated in FIG. 3, fibre channel (109d) is routed through the switch or hub (105a) to the port (107a) and the command device (108a). This constitutes a third pathway (110c) for the SAN through which data can be passed and a command path can be established.

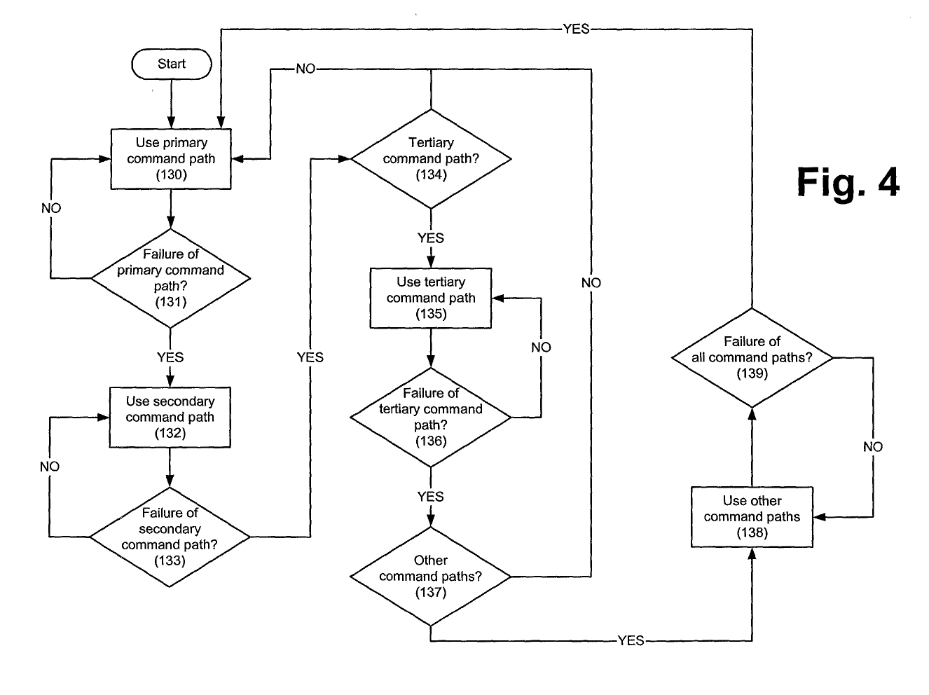

FIG. 4 is a flow chart illustrating the operation of a Storage Area Network with redundant command pathways according to principles of the present invention. As shown in FIG. 4, the operation of a SAN, according to principles of the present event, may begin by using a primary or default command path established through one of the data pathways between the client and data storage sides of the SAN. (130).

In the event that the primary command path fails (131), a second data pathway is used to establish a secondary command path (132). The second data pathway may be designated by the driver of the management station or may be selected randomly by the management station from the remaining, functional data pathways.

In the event that the secondary command path fails (133), the next step will be determined by whether the network has a third or tertiary pathway. If there is a tertiary pathway (134), the system will establish a tertiary command path through that tertiary pathway (135). If no tertiary pathway is present, the system can retry the primary pathway to re-establish the primary command path. If the primary pathway has been repaired or restored, the system can then re-establish the primary command path.

The present invention is not limited to a network with two or three pathways through which a command path can be established. As shown in FIG. 4, if the tertiary command path fails (136), the system can resort to other pathways, if any are present, to establish alternate command paths (137). As long as there is a pathway through which a command path can be established (138), the system can fail over to that pathway.

If all available command paths have failed (136), the system can return to trying the primary command path and again cycle through the pathways until a command path is established. This cycle can continue indefinitely or can be configured to allow for system deactivation at some point. The system may preferably be configured to signal the need for service to system administrators when any command path fails.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A storage area network comprising:
a client device;
a data storage device; and
at least two data pathways between said client device and said data storage device in which said client device can establish a command path for controlling said data storage device, wherein said client device is configured to establish a new command path in a different pathway upon failure of an existing command path.

2. The network of claim 1, further comprising at least three pathways between said client device and said data storage device in which said client device can establish a command path for controlling said data storage device.

3. The network of claim 1, wherein said data storage device comprises at least one disk array.

4. The network of claim 1, wherein said client device comprises
a management station; and
at least one host device networked with said management station.

5. The network of claim 1, wherein each of said data pathways comprises a fiber channel.

6. The network of claim 1, wherein each of said data pathways comprises:
a host device connected to said client device;
a host bus adapter connecting said host device to a fibre channel;
a port of said data storage device; and
a command device within said data storage device.

7. The network of claim 1, wherein said client device comprises a plurality of host devices connected to a management station, wherein each of said host devices is connected to at least one of said pathways.

8. The network of claim 7, wherein at least one host device is connected to at least two of said pathways.

9. The network of claim 7, wherein said host devices are connected to said pathways through host bus adapters.

10. A method of operating a storage area network that comprises a client device, a data storage device, and at least two data pathways between said client device and said data storage device in which said client device can establish a command path for controlling said data storage device, said method comprising, upon failure of an existing command path between said client device and said data storage device, establishing a second command path between said client device and said data storage device in one of said pathways.

11. The method of claim 10, wherein said establishing a second command path is performed in a physically different pathway than supported said previous command path.

12. The method of claim 10, further comprising providing at least three pathways between said client device and said data storage device in which said client device can establish a command path for controlling said data storage device.

13. The method of claim 12, further comprising, each time a command path fails, establishing a new command path in another of said pathways.

14. The method of claim 10, wherein said data storage device comprises at least one disk array, said method further comprising controlling said disk array with commands from said client device delivered via an active command path.

15. A method of assembling a storage area network, said method comprising:
providing at least two data pathways between a client device and a data storage device in which said client device can establish a command path for controlling said data storage device; and
configuring said client device to establish a new command path in a different pathway upon failure of an existing command path.

16. The method of claim 15, further comprising providing at least three pathways between said client device and said data storage device in which said client device can establish a command path for controlling said data storage device.

17. The method of claim 15, further comprising forming said data storage device with at least one disk array.

18. The method of claim 15, further comprising forming said client device by connecting at least one host device with a management station.

19. The method of claim 18, further comprising connecting each of said host device to at least one of said pathways.

20. The method of claim 19, further comprising connecting at least one of said host devices to at least two of said pathways.

21. The method of claim 15, wherein said providing data pathways comprises forming said data pathways with fiber optic channels.

22. The method of claim 15, wherein said providing data pathways comprises forming each of said data pathways to include:
a host device connected to said client device;
a host bus adapter connecting said host device to a fiber optic channel;
a port of said data storage device; and
a command device within said data storage device.

23. A storage area network, comprising:
a client device;
a data storage device;
at least two data pathways between said client device and said data storage device in which a command path for controlling said data storage device with said client device can be established; and
means for establishing a second command path between said client device and said data storage device in one of said pathways upon failure of an existing command path between said client device and said data storage device.

24. The network of claim 23, further comprising at least three pathways between said client device and said data storage device in which said means for establishing can establish a command path for controlling said data storage device.

25. The network of claim 23, wherein said data storage device comprises at least one disk array.

26. The network of claim 23, wherein said client device comprises
a management station; and
at least one host device networked with said management station.

27. The network of claim 23, wherein each of said data pathways comprises a fiber optic channel.

28. The network of claim 23, wherein each of said data pathways comprises:
a host device connected to said client device;
a host bus adapter connecting said host device to a fiber channel;
a port of said data storage device; and
a command device within said data storage device.

29. A management station for a storage area network, said storage area network comprising a client device, a data storage device and at least two data pathways between said client device and said data storage device in which a command path for controlling said data storage device can be established,
wherein said management station is configured to establish a new command path in a different pathway upon failure of an existing command path.
